(19) United States
(12) Patent Application Publication
(10) Pub. No.: US 2008/0113846 A1
(43) Pub. Date: May 15, 2008

(54) Combination of an internal combustion engine and an electric machine

(75) Inventors: Peter Wiggen, Grafenrheinfeld (DE); Bernd Peinemann, Niederwerrn (DE); Olaf Pagels, Bergrheinfeld (DE); Manfred Zimmer, Zeil (DE); Christoph Kleuker, Schweinfurt (DE); Udo Niehaus, Schonungen (DE); Michael Kuhner, Schwanfeld (DE); Steffen Matschas, Gochsheim (DE); Alexander Bartha, Wurzburg (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/983,908

(22) Filed: Nov. 13, 2007

(30) Foreign Application Priority Data
Nov. 13, 2006 (DE) 10 2006 053 660.6

(51) Int. Cl. B60K 1/02; F02B 73/00

(52) U.S. Cl. 477/3; 60/716

(57) ABSTRACT

A combination drive unit including an internal combustion engine and an electric machine, where the internal combustion engine includes a housing with a crankshaft supported therein; where the electric machine includes a rotor with a rotor shaft, the rotor being supported rotatably on a stationary component, and a stator, which is mounted radially with respect to the rotor. The crankshaft is in working connection with the rotor shaft at least indirectly and at least temporarily by way of a coupling. For the event that the crankshaft and the rotor shaft are offset from each other, the unit has separate first and second compensating devices, so that the wobbling forces which occur during operation of the unit can be absorbed.

### BACKGROUND OF THE INVENTION

1. Field of the Invention

The invention pertains to a unit consisting of an internal combustion engine and an electric machine with a coupling for connecting the rotor shaft to the crankshaft.

2. Description of the Related Art

A unit of this type is already known in the prior art and is used, for example, as a drive arrangement for a hybrid vehicle, where the vehicle, depending on requirements, can be driven either purely by the internal combustion engine, purely by the electric machine, or by both drive systems in a mixed operating mode.

Units of this type must fulfill the requirement that the crankshaft of the internal combustion engine and possibly an added extension thereof and the rotor shaft of the electric machine must be aligned with each other as accurately as possible and thus that any axial and/or radial offset between two shafts is avoided as far as possible. Otherwise, undesirable radial forces act on the shafts and their bearing points during the operation of the unit. Loads which are considerably beyond the intended range are thus imposed on the components just mentioned and can lead to eccentric operation and to premature wear of the unit overall.

An offset between the shafts can occur statically simply as a result of the tolerances associated with the fabrication and installation of the unit. Offsets can also be caused dynamically, e.g., by wobbling movements of the crankshaft during operation of the internal combustion engine.

### SUMMARY OF THE INVENTION

Against this background, an object of the invention is to absorb the forces which occur in the presence of an offset, especially a radial offset, between the crankshaft and the rotor shaft without disadvantageous effects on the service life of the unit.

The invention is based on the idea that a radial offset and possibly an additional angular offset between two coaxially connected shafts cannot be compensated by a single compensating means alone. On the contrary, at least two separate compensating means are necessary for this purpose. Through the effects of these two means, the previously mentioned improper positioning can be compensated in stages. This offers the advantage that the wobbling forces to be absorbed by each of the individual means will be smaller than those which only a single compensating means must absorb, since the overall interfering load can thus be distributed between the two compensating means. Thus, instead of a difficult-to-realize single compensating means with a high degree of elasticity or wobble-absorbing behavior, two or more easier-to-produce and less complicated compensating means with a comparatively smaller degree of wobble-absorbing capacity can be integrated into the unit. The wobbling forces which develop are absorbed in this way by at least two predetermined wobble-absorbing elements, as a result of which other components at risk, e.g., bearings, which are located in the path of the flow of forces are noticeably relieved of stress.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a unit consisting of an internal combustion engine and an electric machine;

FIG. 2 shows a unit according to FIG. 1 with a bearing carrier for supporting the rotor of the electric machine mounted in a wobble-absorbing manner on the internal combustion engine;

FIG. 3 shows a unit according to FIG. 1 with a bearing carrier of wobble-absorbing design for supporting the rotor of the electric machine;

FIG. 4 shows a unit according to FIG. 1, where a wobble-compensating means is provided between a bearing carrier and a bearing; and

FIG. 5 shows a unit according to FIG. 1 with a bearing with freedom of angular movement for supporting the rotor.

### DETAILED DESCRIPTION OF THE PRESENTLY PREFERRED EMBODIMENTS

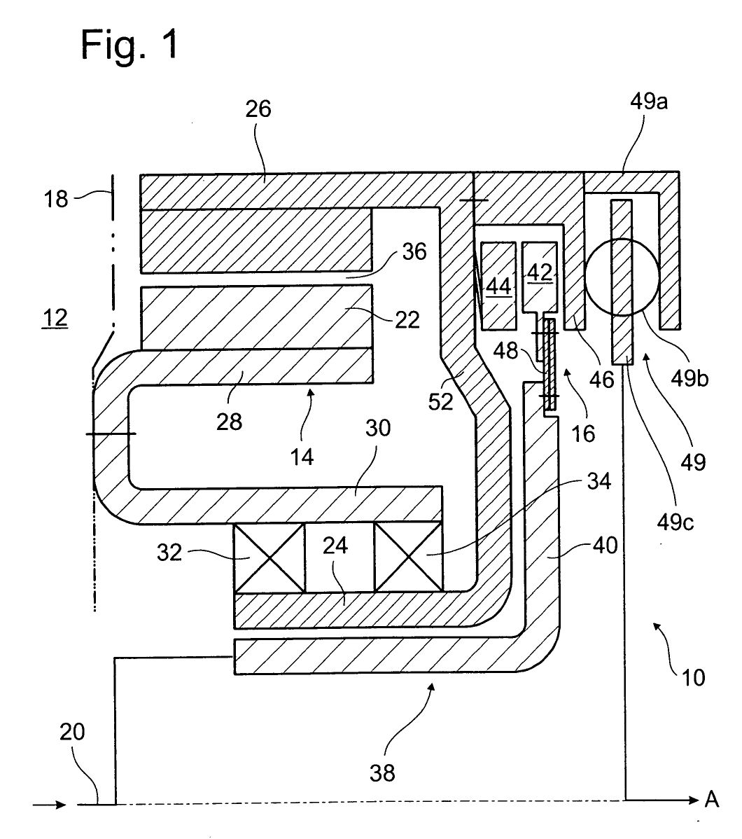

FIG. 1 shows a schematic diagram of the upper half plane of a unit 10, symmetric to an axis A, including an internal combustion engine 12, an electric machine 14, and a shiftable (engageable and disengageable) separating clutch 16, which is installed in working connection between these two other components. The internal combustion engine 12 includes a housing 18 and a crankshaft 20, supported rotatably therein, whereas the electric machine 14 includes a stator 22 and a rotor 26, which rotates on a rotor shaft 24 around the stator. The electric machine 14 in this exemplary embodiment is designed as a permanent magnet-excited synchronous machine of the external rotor type, but it could also be designed with an internal rotor and could operate according to some other functional principle.

The unit 10 is intended to serve as a drive source of a hybrid vehicle, which, depending on the requirements, can be driven either purely by the internal combustion engine, purely by the electric motor, or by both systems 12, 14 in a mixed operating mode. So that the internal combustion engine 12 can be started, the torque can also flow from the electric machine 14 to the internal combustion engine 12.

The electric machine 14 is mounted directly on the internal combustion engine 12, where the stator 22 is installed on the housing 18 of the internal combustion engine 12 by means of a stator carrier 28. The cup-shaped rotor 26 has in its radially inner area a tubular extension, which forms the rotor shaft 24. This shaft engages and is supported in a central opening in a bearing carrier 30, which is mounted on the internal combustion engine housing 18 and overlaps it axially. In FIG. 1, the bearing carrier 30 is tubular and is designed as an integral part of the stator carrier 28. Two roller bearings 32, 34, spaced a certain axial distance apart, are provided on the bearing carrier 30 to support the rotor 26, as a result of which the rotor 26 is supported in operationally reliable fashion with respect to the stator 22, forming a constant radial gap 36 in the circumferential direction.

A driver 38 is mounted on the crankshaft 20, which is shown only schematically in FIG. 1. This driver represents an extension of the crankshaft and is guided concentrically inside the rotor shaft 24. A radially outward-directed section 40 of the driver, parallel to the rotor 26, is provided to transmit torque. The driver 38 thus serves as an input element of the separating clutch 16, which is designed here as a friction clutch. For this purpose, the driver has a clutch disk 42, consisting of a clutch lining carrier with friction linings on both sides, in its radially outer area. The separating clutch 16 is completed by an axially adjacent pressure plate 44, which can be shifted toward the clutch disk 42 by an actuating system (not shown), and by an opposing pressure plate 46, which is installed on the opposite site and is supported on the rotor 26.

When the clutch is engaged, the clutch disk 42 therefore serves as a connecting element between the crankshaft 20 on the one side and the rotor 26, i.e., the rotor shaft 24, on the other side. Between its radial section 40 and the clutch disk 42, the driver 38 has in addition a ring-shaped area 48 of wobble-absorbing design made, for example, of spring plate. When there is an offset between the shafts 20, 24 and certain forces are thus generated, this area is able to be deformed elastically. It therefore functions as a first compensating means for compensating for an offset between the crankshaft 20 and the rotor shaft 24.

FIG. 1 also shows a torsional vibration damper 49, the input part 49a of which is formed by a housing permanently mounted on the rotor side. This input part can transmit torque introduced from this housing by way of at least one intermediate spring element 49b to a disk-shaped, radially inward-extending output part 49c, as a result of which any torque surges which may occur can be absorbed. The torque can then be transmitted onward, e.g., by way of a shiftable clutch and a shift transmission, to the wheels of the vehicle.

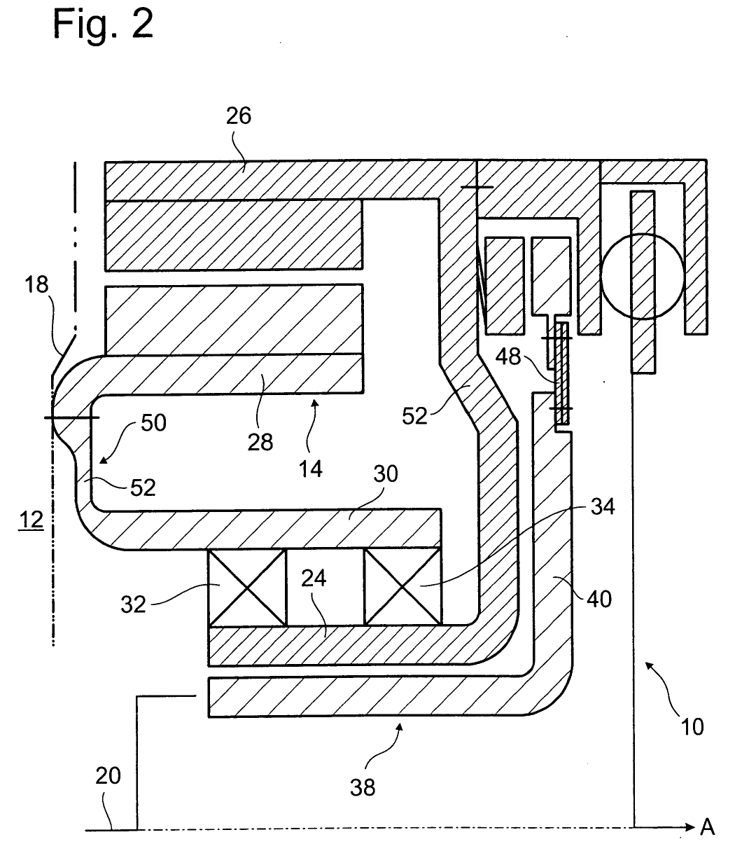

In FIGS. 2-5, another, second compensating means for compensating for an offset between the crankshaft 20 and the rotor shaft 24 is provided on a unit 10 according to the invention. Unless otherwise described, the basic design of these units 10 is the same as that shown in FIG. 1.

To provide a second compensating means, a section of the bearing carrier 30 located outside the actual bearing point is designed with the ability to absorb wobbling movements or that the bearing carrier as a whole be mounted on, or suspended from, its support structure, e.g., the internal combustion engine, in a wobble-absorbing manner. In particular, the tubular bearing carrier 30 shown in FIG. 2 is mounted on the internal combustion engine housing 18 by means of a radial flange 50, and a certain area 52 of the radial flange 50 is designed with a taper and can thus be elastically deformed to a certain extent under the action of wobbling movements and in this way absorb the wobbling forces acting upon it. It is also possible to install an elastic, e.g., rubber, intermediate element between the support structure, here the internal combustion engine housing 18, and the bearing carrier 30, as a result of which the bearing carrier 30, which is rigid in itself, can be caused to wobble.

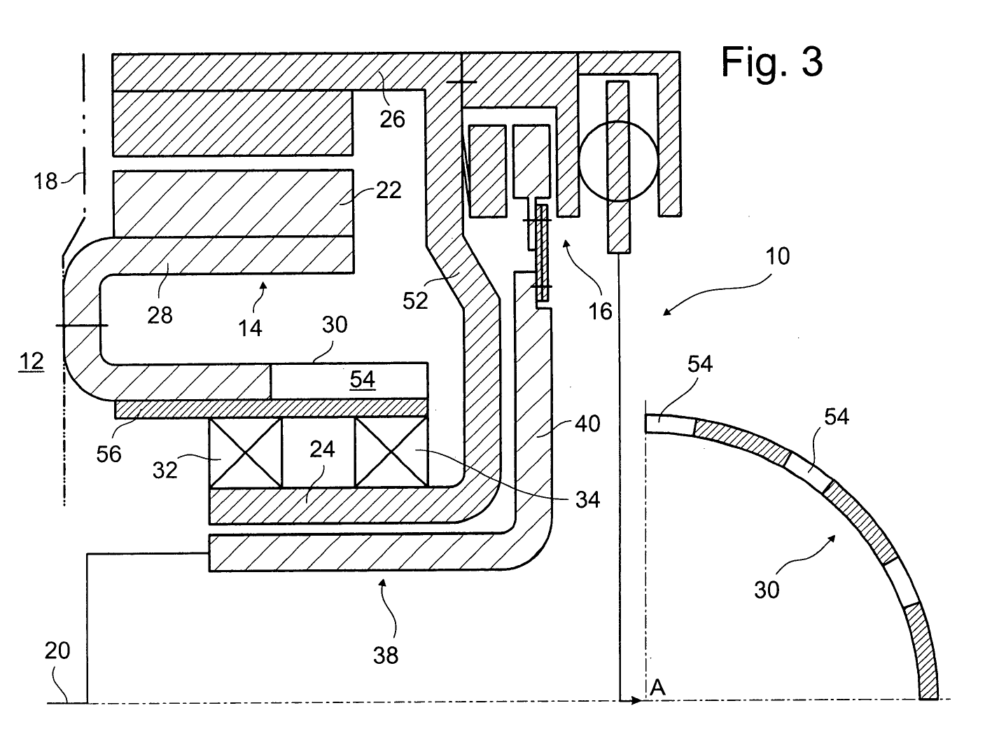

In another exemplary embodiment, namely, that according to FIG. 3, the bearing carrier 30 itself has a wobble-absorbing design to provide the second compensating means. For this purpose, several axial slots 54 are introduced into the area of the bearing carrier 30 facing the back 52 of the rotor, these slots being spaced a certain distance apart in the circumferential direction, so that, when a wobbling force acts on the carrier, the slotted axial section is able periodically to shift position radially with respect to the adjacent axial section and thus absorb the wobbling forces.

It can be seen that a fitted sleeve 56 has been inserted, and that the roller bearing 34 is mounted axially in the slotted area, whereas the bearing 32 is outside this area, so that, when a load is imposed, the axially spaced bearings 32, 34 can shift position radially with respect to each other.

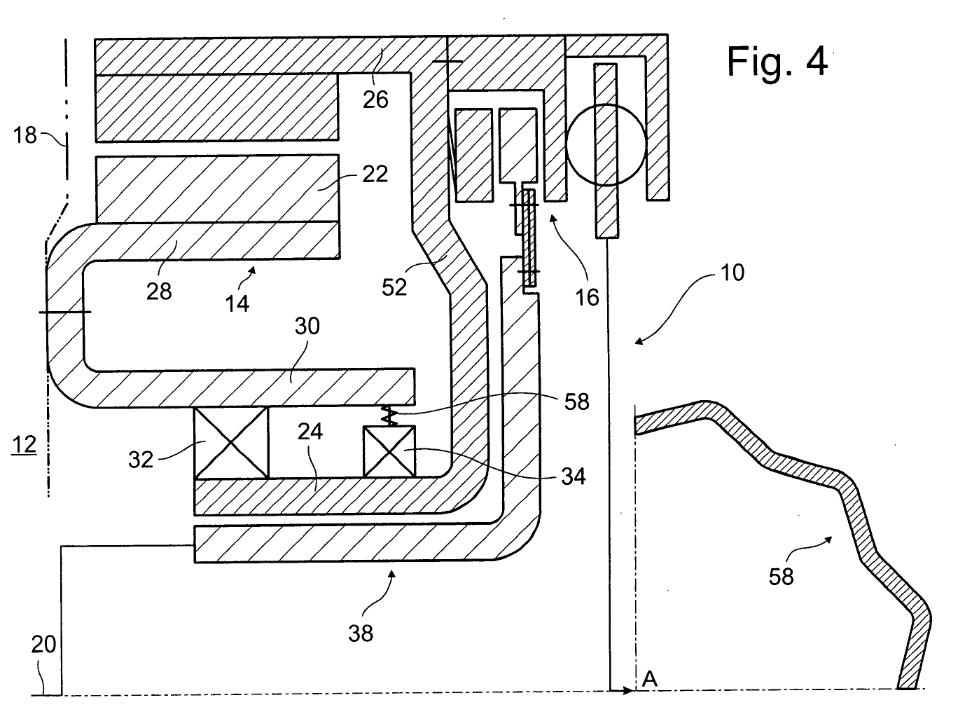

According to yet another variant of a unit 10 as shown in FIG. 4, the second compensating means can also be installed between a rotor bearing 34 and a bearing carrier 30. For this purpose, the bearing 34 facing the back 52 of the rotor is installed on the bearing carrier 30 by means of a ring-shaped element 58, e.g., a contoured sheet-metal ring or possibly a rubber ring, which is elastic in the radial direction. The other roller bearing 32, i.e., the one on the internal combustion engine side, is dimensioned in such a way that it oscillates within a short angular range and can thus act as a joint. In this case, too, the rotor 26 can be allowed to wobble without causing any impairment to the service life of the unit 10.

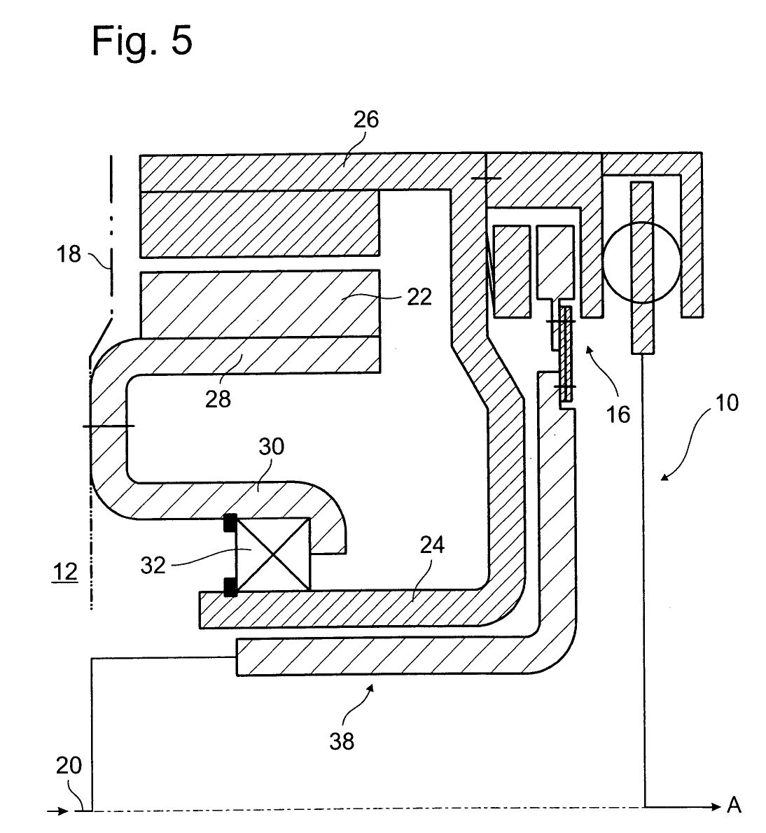

As shown in FIG. 5, furthermore, it is also possible to provide only a single roller bearing 32 and to omit the one or more additional bearings. The single roller bearing 32 is now designed with freedom of angular movement with increased bearing play or as a self-aligning ball bearing.

Insofar as technically feasible, the compensating means described on the basis of FIGS. 1-5 can also be combined with each other and realized in a unit, so that the coupling means acting in common will together be able to achieve the necessary wobble compensation.

It is obvious that the stator and the rotor of the electric machine could also be supported on some other component permanently mounted on the internal combustion engine, e.g., on an intermediate housing connected to it or on a transmission housing of a gear-changing transmission downline from the unit. The stator could also be mounted on one of the other components mentioned, independently of the rotor.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A combination drive unit comprising:
an internal combustion engine comprising a housing and a crankshaft supported for rotation in the housing;
an electric machine comprising a stator and a rotor which is mounted radially with respect to the stator, the rotor being supported for rotation on a stationary component;
a coupling for connecting the rotor shaft to the crankshaft at least indirectly and at least temporarily;
first compensating means for compensating for an offset between the crankshaft and the rotor shaft; and
second compensating means for compensating for an offset between the crankshaft and the rotor shaft.

2. The combination drive unit of claim 1 wherein the rotor is supported on the housing of the internal combustion engine.

3. The combination drive unit of claim 1 wherein the first compensating means is on the internal combustion engine side of the coupling, and the second compensating means is on the electric machine side of the coupling.

4. The combination drive unit of claim 1 wherein the first compensating means is a wobble absorbing coupling element.

5. The combination drive unit of claim 1 wherein the rotor is supported for rotation on a bearing carrier by at least one bearing.

6. The combination drive unit of claim 5 wherein the bearing carrier is suspended from the housing in a wobble-absorbing manner.

7. The combination drive unit of claim 5 wherein the bearing carrier is designed to absorb radial waddle of the rotor with respect to the crankshaft.

8. The combination drive unit of claim 5 wherein the second compensating means is located between the bearing carrier and the bearing.

9. The combination drive unit of claim 8 wherein the bearing is supported for radial movement with respect to the bearing carrier.

10. The combination drive unit of claim 1 wherein the coupling is a shiftable clutch.

11. The combination drive unit of claim 1 wherein the stator is fixed to the housing of the engine.
